(19) United States
(12) Patent Application Publication
(10) Pub. No.: US 2007/0018804 A1
(43) Pub. Date: Jan. 25, 2007

(54) Transponder for tires

(75) Inventors: Wolfgang Strache, Hannover (DE); Jorg Lehmann, Hannover (DE); Holger Behrends, Hannover (DE); Marc-Andre Besson, Garbsen (DE); Carla Recker, Hannover (DE); Roland Jenke, Hademstorf (DE); Volker Hartel, Germering (DE); Andreas Wulf, Auhagen (DE)

Correspondence Address: WALTER OTTESEN, PO BOX 4026, GAITHERSBURG, MD, 20885-4026, US

(73) Assignee: Continental Aktiengesellschaft

(21) Appl. No.: 11/528,460

(22) Filed: Sep. 28, 2006

Related U.S. Application Data
(62) Division of application No. 10/664,154, filed on Sep. 17, 2003.

(30) Foreign Application Priority Data
Sep. 18, 2002 (DE) 102 43 441.7

(51) Int. Cl. B60C 23/00

(52) U.S. Cl. 340/442; 152/152.1

(57) ABSTRACT

The invention relates to a transponder which is mounted in a tire. The transponder includes at least a transponder chip and a transponder antenna and is embedded in a substrate. The substrate is connected to an inner side of the tire by a connecting structure. In order to provide a transponder with the longest possible service life, the substrate is decoupled from the inner side of the tire via a connecting structure in the form of a soft or gliding support in such a manner that no or only minimum mechanical stresses are transmitted to the substrate. The connecting structure is arranged between the substrate and the inner side of the tire.

### CROSS REFERENCE TO RELATED APPLICATION

This is a divisional application of application Ser. No. 10/664,154, filed Sep. 17, 2003, claiming priority from German patent application 102 43 441.7, filed Sep. 18, 2002, and incorporated herein by reference.

### FIELD OF THE INVENTION

The invention relates to a transponder which is mounted on a tire. The transponder includes at least a transponder chip and a transponder antenna and is embedded in a substrate. The substrate is connected to the inner side of the tire via a suitable means.

### BACKGROUND OF THE INVENTION

Transponders are utilized in tires for various tasks. One of these tasks is especially tire identification which enables an automobile manufacturer to rapidly and automatically determine from which tire factory a specific tire was delivered. Other tasks can include: a monitoring of pressure, a temperature measurement, the measurement of mechanical stress conditions in the tire or a measurement of running capacity of the tire which has already been travelled. Modern transponders comprise an electronic component or chip in which sensor elements can be arranged as well as an antenna connected to this electronic component.

A problem with tire transponders is associated with the arrangement of the transponder in the tire. German patent publication 4,426,022 discloses, for example, a transponder which is arranged in a so-called container which, in turn, is fixed to the tire inner side with adhesive. The container functions as a housing and the container as well as a stiffer carrier layer, which lies between the transponder and the inner side of the tire, are fixedly connected to the transponder. A significant disadvantage of this composite arrangement is that high loads are transmitted to the transponder because of the occurring deformations during the operating state of the tire. These loads either lead to damage of the transponder antenna or to a breakage of the connecting location between transponder chip and transponder antenna. The transponder can then no longer be used for data transmission because of the irreversible damage.

### SUMMARY OF THE INVENTION

It is an object of the invention to provide a transponder for building into a tire which transponder has a service life as long as possible.

The transponder arrangement of the invention is for mounting in a tire defining an inner side. The transponder arrangement includes: a substrate; a transponder embedded in the substrate and including a transponder chip and an antenna; a connecting structure disposed between the substrate and the inner side of the tire; the connecting structure being in the form of a soft or sliding support; and, the substrate being decoupled from the inner side by the connecting structure in such a manner that no or only minimal stresses are transmitted to the substrate.

An advantage of the invention is especially that the loads, which act upon the transponder, are significantly reduced because of the soft or gliding support. In the arrangement of the invention, the portion of the thrust stresses and normal stresses, which are transmitted to the transponder, are negligibly low. This effect applies likewise for the alternate bending stress load which acts on the transponder in the operating state of the tire and is greatly reduced because of the achieved decoupling. The transponder thereby has, in total, a significantly longer service life.

In an advantageous embodiment of the invention, the connecting structure is configured as a cushion support. In this form of decoupling, a soft material cushion is mounted between the transponder and the inner side of the tire. The cushion support is a construction, which can be especially simply realized in order to achieve a decoupling.

In another advantageous embodiment of the invention, the cushion support is made of a silicone layer. Silicone has a viscous elastic material characteristic and is therefore especially suitable as a soft support. Furthermore, this material can be easily processed.

In a further advantageous embodiment of the invention, the cushion support comprises an air cushion, gel cushion or foam cushion. With these materials, a soft support is likewise obtained in a simple manner.

In a further advantageous embodiment of the invention, the cushion support is made of cellular rubber. Here, the cushion support is a closed-cell elastomer foam which has additional damping characteristics in order to compensate for the occurring loading.

In a further advantageous embodiment of the invention, the cushion support is a leg-like or strut-like structure. The leg-like connecting structure contributes to an increased decoupling between the transponder and the inner side of the tire.

According to still another feature of the invention, the substrate and the cushion support are covered by a patch which is connected to the inner side of the tire. In this way, an adhesive connection between the transponder, which is embedded in the substrate, and the cushion support is unnecessary. As a consequence, only negligible thrust stresses are transmitted between the transponder and the cushion support.

According to another feature of the invention, the substrate is covered by a patch which is connected to the inner side of the tire. A partition medium is disposed between the substrate and the inner side of the tire and the substrate can slideably move on this partition medium. In this arrangement, the transponder, which is embedded in the substrate, slideably moves on the partition medium whereby only very low thrust stresses are transmitted to the transponder. An advantageous embodiment of the partition medium is a foil.

In another advantageous embodiment of the invention, a partition medium is arranged between the substrate and the patch. The partition medium is, for example, in the form of a powder, gel or a solution and eliminates an adhesion between the transponder, which is embedded in the substrate, and the rubber material of the patch. In this way, only low thrust stresses can be transmitted from the patch or covering.

In a further advantageous embodiment of the invention, the patch is permeable to air at least at one location. In this way, the same air pressure is present in the hollow space between the patch and the inner side of the tire whereby the load on the transponder during operation of the tire is less.

In a further advantageous embodiment of the invention, the substrate is supported in a fluid in a cavity. The transponder is embedded in the substrate and supported to float freely in the fluid so that neither thrust nor normal stresses can be transmitted to the substrate.

In a further advantageous embodiment of the invention, it is provided that the substrate is connected to the inner side of the tire via at least one connecting leg which defines the connecting structure. In this embodiment, a mushroom-shaped connecting structure is present which is characterized likewise by a high degree of decoupling between the transponder and the inner side of the tire.

In another embodiment of the invention, the substrate is connected to the connecting leg via a latch or snap connection. In this way, the transponder can be easily connected to the connecting leg and, if necessary, can again be separated therefrom.

In another advantageous embodiment of the invention, the substrate has an arcuately-shaped housing contour adapted to the inner side of the tire. In this way, it is ensured that the transponder does not come into contact with the inner side of the tire even during contact and during non-contact.

In still another embodiment of the invention, the substrate is mounted in a patch or covering which is fixedly connected to the inner side of the tire only at one or several component regions. In this embodiment, only minimum thrust stresses are transmitted to the transponder.

In still another embodiment of the invention, a partition medium is disposed between the patch and the inner side of the tire. The partition medium prevents an adhesion between the patch and the inner side of the tire whereby the decoupling effect is increased.

### BRIEF DESCRIPTION OF THE DRAWINGS

The invention will now be described with reference to the drawings wherein:

FIG. 1 is a schematic of a transponder embedded in a substrate and arranged on the inner side of a tire with the transponder having a connecting structure in the form of a cushion support;

FIG. 2 is a schematic of a cushion support having strut-shaped connecting structures;

FIG. 3 is a connecting structure covered by a patch;

FIG. 4 is a connecting structure wherein a partition medium is disposed between the transponder and the inner side of the tire;

FIG. 5 is a schematic of a transponder which is mounted in a fluid in a cavity of the patch;

FIG. 6 is a transponder, which is embedded in a substrate and which is connected to the inner side of a tire via two connecting legs;

FIG. 7 is a schematic of a transponder, which is embedded in a substrate, and which is connected to the inner side of a tire via a tube-shaped holder;

FIG. 8 is a schematic of a transponder, which is embedded in a substrate, and which is connected to a connecting leg via a snap connection;

FIG. 9 is a schematic of a transponder, which is mounted in a patch, and which is connected to the inner side of a tire only at one component region; and,

FIG. 10 is a plan view of the embodiment shown in FIG. 9.

### DESCRIPTION OF THE PREFERRED EMBODIMENTS OF THE INVENTION

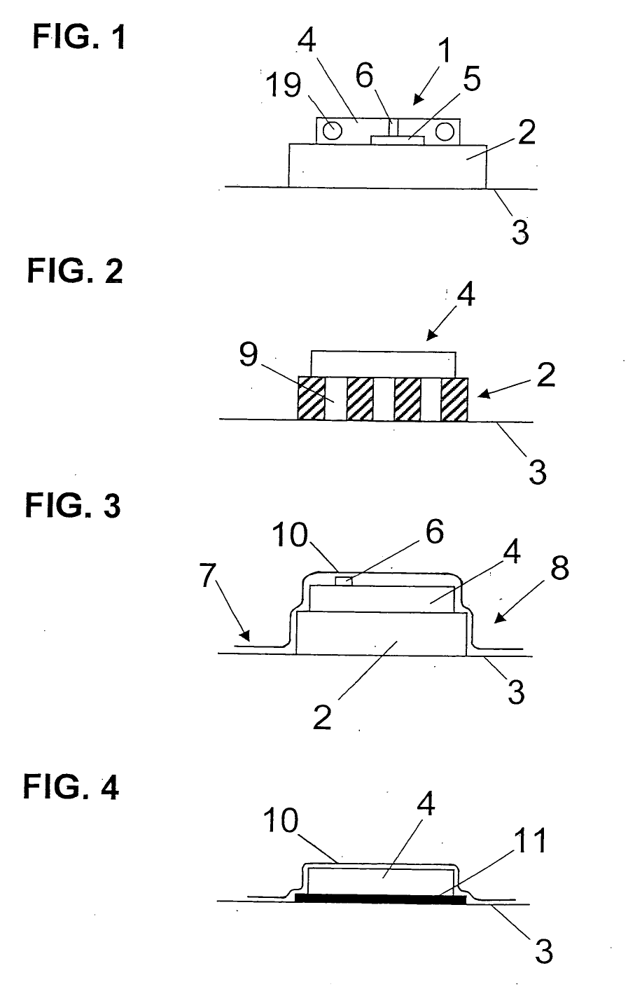

FIG. 1 shows a transponder 1, which is embedded in a substrate 4, and is mounted on the inner side 3 of a tire with a connecting structure in the form of a cushion support 2. The transponder comprises a transponder chip 5 and an antenna coil 19 which are embedded in the substrate 4. The substrate 4 functions as a housing and can, for example, be composed of epoxy resin, a plastic, rubber, elastomer or a foil. The transponder 1 is therefore not in direct connection with the cushion support 2 which defines the connecting structure to the inner side 3 of the tire. The cushion support 2 can be made of various soft materials and especially of a silicone material. It is likewise possible that the cushion support comprises an air gel or a foam cushion. The substrate 4 is, for example, connected to the cushion support 2 via an adhesive connection. In the substrate 4, an opening 6 can be provided via which the air pressure can be measured which is present in the hollow space of the tire. This opening 6 is likewise provided in the embodiments in the following FIGS. The cushion support 2 has the function to decouple the transponder 1 and the substrate 4 surrounding the same from the inner side of the tire in that the cushion support 2 absorbs most of the deformations and stresses coming from the inner side of the tire. While the occurring deformations and mechanical stresses are very large on the side of the cushion support 2 facing toward the inner side 3 of the tire, only negligible stress conditions or deformations are present on the opposite-lying side of the cushion support 2. In this way, hardly any stresses or deformations are transmitted to the enclosing substrate 4 of the transponder 1 whereby the service life of the transponder 1 is considerably lengthened.

FIG. 2 shows a cushion support 2 having a leg-shaped or strut-like connecting structure. In FIG. 2 as well as in the following FIGS., the transponder with the transponder chip and transponder antenna are not explicitly shown. Only the substrate 4 is shown in each case in which the transponder with its components is embedded. The same applies to the opening 6 in FIG. 1. The cushion support 2 distinguishes from the first embodiment of FIG. 1 in that the cushion support has several recesses 9. These recesses 9 contribute to reducing the stiffness of the cushion support. In this way, the stress transfer from the inner side of the tire to the transponder 1 or to the surrounding substrate is further reduced.

FIG. 3 shows a connecting structure covered by a patch 10. This embodiment corresponds essentially to the first embodiment of FIG. 1. The transponder, which is embedded in the substrate 4, is held on the inner side 3 of the tire with the aid of a patch 7 whereby no adhesive connection is needed between the cushion support 2 and the substrate 4 surrounding the transponder. Only minimal thrust stresses can be transmitted because of the free movability of the substrate 4 on the cushion support 2.

FIG. 4 shows a connecting structure wherein a partition medium 11 is arranged between the substrate 4 and the inner side 3 of the tire. The partition medium 11 can, for example, be made of a plastic foil on which the transponder 1, which is embedded in the substrate 4, can slide freely. In this way, only negligible thrust stresses are transmitted. A partition means should likewise be provided between the patch 10 and the substrate 4 so that an adhesion to the rubber material of the patch is avoided. A fat layer, oil layer, powder layer or silicone layer can serve as a partition means and is applied as a solution or paste to the substrate 4. It is likewise conceivable that the total substrate 4 is coated with such a partition means in order to be able to do without the partition medium 11. The partition means, as the partition medium 11, has the function to prevent an adhesion between the substrate 4 and the surrounding rubber material. In this way, only slight thrust stresses can be transmitted to the substrate 4 which would otherwise lead to damage of the transponder.

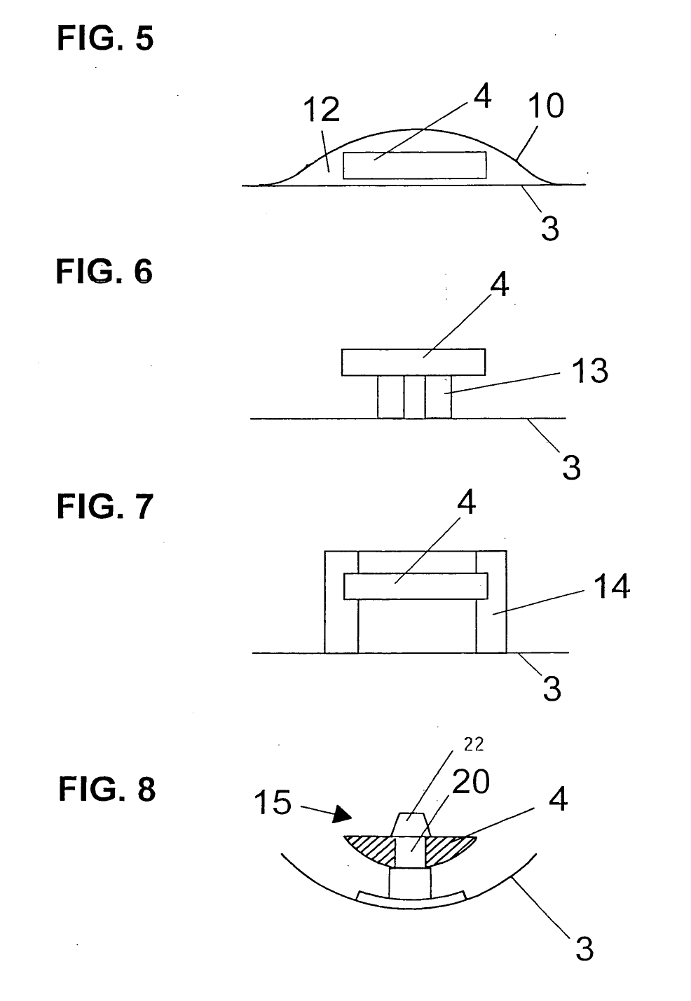

FIG. 5 shows a transponder, which is embedded in a substrate 4, and which is arranged in a fluid 12 in a cavity of the patch 10. The transponder is embedded in the substrate 4 and is supported so as to freely float in the fluid so that neither thrust stress nor normal stress can be transmitted to the substrate 4. A silicone oil can be used, for example, as the fluid.

FIG. 6 shows a transponder embedded in a substrate 4. The transponder is connected to the inner side 3 of the tire via two connecting legs. The connecting legs comprise a flexible material and, because of the low stiffness of the connecting structure, only a minimum stress is transmitted to the substrate 4.

FIG. 7 shows a transponder embedded in a substrate 4 which is connected to the inner side 3 of the tire via a tubularly-shaped holder 14. The substrate 4 therefore is connected to the tubularly-shaped holder 14 only at its outer edges. The holder 14 is, in turn, connected to the inner side 3 of the tire, for example, via an adhesive connection.

FIG. 8 shows a transponder, which is embedded in a substrate 4, and which is connected to a connecting leg 20 via a snap connection 15. In this embodiment, the substrate 4 has a cutout which, together with the mushroom-shaped end 22 of the connecting leg 20, ensures a form-tight connection. Furthermore, the substrate 4 has a sickle-shaped outer contour which is adapted to the contour of the inner side of the tire. In this way, it is ensured that the substrate 4 is not in contact with the inner side 3 of the tire.

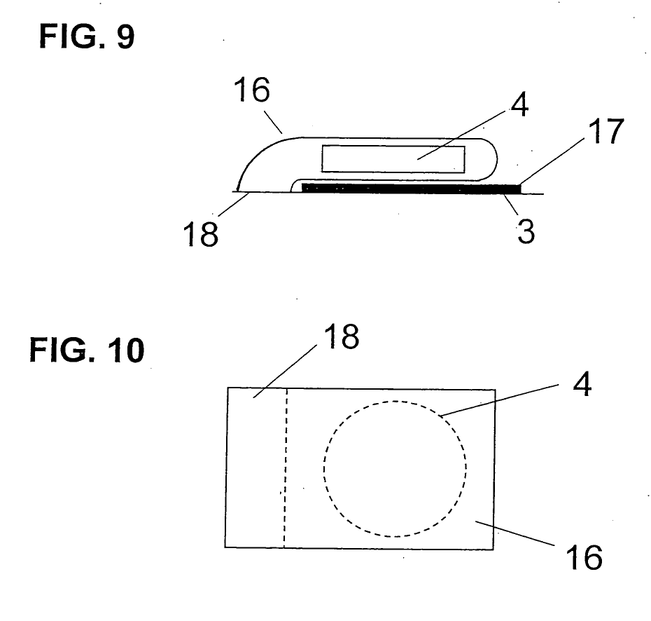

FIG. 9 shows a transponder arranged in a patch 16. The patch 16 is connected to the inner side 3 of the tire in only a component region. The substrate 4 is completely embedded in the patch 16. Furthermore, a partition medium 17 can be provided between the patch 16 and the inner side of the tire which prevents an adherence of the patch 16 to the inner side 3 of the tire. In this way, no thrust stresses can, in turn, be transmitted to the transponder. The component connecting structure 18 of the patch 16 can, for example, be connected to the inner side 3 of the tire by an adhesive.

FIG. 10 is a plan view of the embodiment of FIG. 9. The circle 4 shown in phantom outline shows the outer contour of the transponder embedded in the substrate 4. The patch 16 is connected to the inner side of the tire only via the partial connecting structure 18.

This application claims priority from German patent application 102 43 441.7, filed Sep. 18, 2002, and said German patent application is incorporated herein by reference.

It is understood that the foregoing description is that of the preferred embodiments of the invention and that various changes and modifications may be made thereto without departing from the spirit and scope of the invention as defined in the appended claims.

1. A transponder arrangement for mounting in a tire defining an inner side, the transponder arrangement comprising:
a substrate;
a transponder embedded in said substrate and including a transponder chip and an antenna;
a connecting structure disposed between said substrate and said inner side of said tire;
said connecting structure being in the form of a soft or sliding support; and,
said substrate being decoupled from said inner side by said connecting structure in such a manner that no or only minimal stresses are transmitted to said substrate.

2. The transponder arrangement of claim 1, wherein said connecting structure is configured as a cushion support.

3-6. (canceled)

7. The transponder arrangement of claim 2, further comprising a patch covering said substrate and said cushion support; and, said patch being connected to said inner side of said tire.

8. The transponder arrangement of claim 7, further comprising partition means arranged between said substrate and said inner side of said tire; and, said substrate being disposed on said partition medium so as to be slideably movable thereon.

9-16. (canceled)

17. A tire comprising:
a tire wall having an inner side;
a transponder arrangement disposed is said tire;
said transponder arrangement including:
a substrate;
a transponder embedded in said substrate and including a transponder chip and an antenna;
a connecting structure disposed between said substrate and said inner side of said tire;
said connecting structure being in the form of a soft or sliding support; and,
said substrate being decoupled from said inner side by said connecting structure in such a manner that no or only minimal stresses are transmitted to said substrate.

18. The transponder of claim 8, wherein said partition means is a plastic foil.

19. The transponder of claim 8, wherein said partition means is a first partition means and said transponder comprises a second partition means disposed between said patch and said substrate for preventing adhesion between said patch and said substrate.

20. The transponder of claim 19, wherein said second partition means is a layer selected from the group comprising: a fat layer, oil layer, powder layer and silicone layer.
